(19) United States
(12) Patent Application Publication
(10) Pub. No.: US 2023/0266980 A1
(43) Pub. Date: Aug. 24, 2023

(54) METHOD FOR PROVIDING REMOTE SECURITY SERVICE AND SERVER PERFORMING THE SAME

(71) Applicant: ERmind Co., Ltd., Seoul (KR)

(72) Inventors: Chul Oh Park, Yangpyeong-gun, Gyeonggi-do (KR); Min Chul Kim, Seoul (KR); Jeong Moon Kim, Seoul (KR)

(73) Assignee: ERmind Co., Ltd., Seoul (KR)

(21) Appl. No.: 18/097,620

(22) Filed: Jan. 17, 2023

(30) Foreign Application Priority Data
Feb. 24, 2022 (KR) 10-2022-0024544

(51) Int. Cl. G06F 9/451; G06F 3/14; H04L 9/06

(52) U.S. Cl. CPC G06F 9/452; G06F 3/1454; H04L 9/0643

(57) ABSTRACT

The present disclosure relates to a method for providing a remote security service, comprising: providing a screen of a web page being accessed through a remote browser to a user device; monitoring whether an execution event for a context menu included in the web page occurs; encrypting an event constituting the context menu when the execution event occurs; generating a virtualization context menu corresponding to the encrypted event; receiving any one event which is selected from the virtualization context menu; and processing an encrypted work corresponding to the event through the remote browser, and providing the processed, encrypted work to the user device.

### CROSS-REFERENCE TO RELATED APPLICATIONS

This application claims the priority of Korean Patent Application No. 10-2022-0024544 filed on Feb. 24, 2022, in the Korean Intellectual Property Office, the disclosure of which is incorporated herein by reference.

### BACKGROUND

### Field

The present disclosure relates to a method for providing a remote security service and a server for performing the same.

### DESCRIPTION OF THE RELATED ART

To protect a user device from external hacking, cloud computing systems are being used to a request of the user device. The cloud computing system is a virtualization technology-based system that executes an operating system and programs of the device in a remote virtual computer.

Specifically, a virtualization system includes virtual machines allocated to each of user devices and a virtual machine monitor or hypervisor that manages the virtual machine. Each virtual machine exists as an isolated space. Accordingly, even when a threat occurs in the virtual machine, the virtualization system does not affect other virtual machines and virtual machine monitors except for the corresponding virtual machine. So, the virtualization system is used in security solutions.

The virtualization systems are generally considered safe from external threats because entire data processing is performed in a virtual space. However, security vulnerabilities exist because the virtualization system does not precede safety verification in the process of the receiving data from the user device.

The description of the related art has been prepared to facilitate understanding of the invention. It should not be construed as acknowledging that matters described in the description of the related art exist as prior arts.

### SUMMARY

For example, a web browsing service based on virtualization technology, a remote browser may replace a browser of the user device. Specifically, the web browsing service may perform web browsing in a remote browser, stream the result, and provide it to the user device. The web browsing is performed through a clicking of a main button (usually, a left button) of an input device (mouse) in the user device.

However, when an input device auxiliary button (usually, a right button) is selected in the user device, even in a virtualization system, a context menu is not executed and provided, and event data of the context menu stored in a web page or web browser is delivered as it is. Therefore, if safety verification of event data is not performed, the data may pose a threat.

Accordingly, a method for safely protecting a user device while executing a context menu and processing an event is required.

As a result, the inventors of the present disclosure intended to develop a method for safely protecting a user device from external threats by not providing a context menu to the user device as it is. Specifically, the inventors of the present invention configured to provide an encrypted value for a context menu and a newly generated context menu to the user device.

In particular, the inventors of the present disclosure have come to develop a method capable of limited processing of events requested by the user device among context menus according to a verification result of an encrypted value provided by the user device. Through this, the inventors of the present invention configured to prevent a situation where an entire context menu becomes a target of a threat due to encryption key.

The aspects of the present disclosure are not limited to the aspects mentioned above, and other aspects not mentioned will be clearly understood from the description below.

A method for providing a remote security service according to an exemplary embodiment of the present disclosure is provided. The method may include providing a screen of a web page, which is being accessed through a remote browser to a user device; monitoring whether an execution event for a context menu included in the web page occurs; encrypting an event constituting the context menu when the execution event occurs; generating a virtualization context menu corresponding to the encrypted event; receiving any one event which is selected from the virtualization context menu; and processing an encrypted work corresponding to the event through the remote browser, and providing the processed, encrypted work to the user device.

According to a feature of the present disclosure, the method may further include after the monitoring of whether the event occurs, confirming a type of an item selected through the user device among items constituting the screen of the web page.

According to another feature of the present disclosure, the items constituting the screen of the web page may include at least one item of a background image, an inserted image, a video, and text, and the confirming of the type may include confirming whether a link (URL) or event corresponding to the item exists.

According to still another feature of the present disclosure, the encrypting of the event may include encrypting data constituting the confirmed link or event.

According to still another feature of the present disclosure, the encrypting of the data may further include inputting each of a plurality of events constituting the context menu into a hash function; and acquiring hash values for each of the plurality of events.

According to still another feature of the present disclosure, the plurality of events may be composed of work data including at least one of a link (URL) corresponding to the item, and an image and text constituting the event.

According to still another feature of the present disclosure, the generating of the virtualization context menu may further include transmitting the hash values for each of the plurality of events to the user device, and the providing to the user device may further include receiving a hash value corresponding to the selected event among the hash values for each of the plurality of events.

According to still another feature of the present disclosure, the providing to the user device may further include determining an event corresponding to the received hash value among the plurality of events, and processing a work corresponding to the event determined through the remote browser, and rendering a processed new web page screen.

According to still another aspect of the present disclosure, the providing of the screen of the web page may further include acquiring browser access data from the user device, and rendering a web page corresponding to the browser access data.

According to still another feature of the present disclosure, the browser access data may include at least one of an operating system of the user device, a browser type, and browser setting data of a user.

A remote security service providing server according to another exemplary embodiment of the present disclosure is provided. The server includes a communication interface; a memory; and a processor operatively coupled to the communication interface and the memory, wherein the processor is configured to provide a screen of a web page, which is being accessed through a remote browser to a user device, monitor whether an execution event for a context menu included in the web page occurs, encrypt an event constituting the context menu when the execution event occurs, generate a virtualization context menu corresponding to the encrypted event, receive any one event which is selected from the virtualization context menu, and process the encrypted event corresponding to the event through the remote browser, and provide the processed, encrypted event to the user device.

According to a feature of the present disclosure, the processor may be configured to confirm a type of an item selected through the user device among items constituting the screen of the web page.

According to another feature of the present disclosure, the processor may be configured to confirm whether a link (URL) or event corresponding to the item exists.

According to still another feature of the present disclosure, the processor may be configured to encrypt data constituting the confirmed link or event.

According to still another feature of the present disclosure, the processor may be configured to input each of a plurality of events constituting the context menu into a hash function; and acquire hash values for each of the plurality of events.

According to still another feature of the present disclosure, the processor may be configured to transmit the hash values for each of the plurality of events to the user device, and receive a hash value corresponding to the selected event among the hash values for each of the plurality of events.

According to still another feature of the present disclosure, the processor may be configured to determine an event corresponding to the received hash value among the plurality of events, process a work corresponding to the determined event through the remote browser, and render a processed new web page screen.

According to still another feature of the present disclosure, the processor may be configured to acquire browser access data from the user device and render a web page corresponding to the browser access data.

The details of other embodiments are included in the detailed description of invention and drawings.

According to the present disclosure, a security service providing server encrypts each of events of a context menu stored and executed in an operating system or web browser and delivers only an encrypted value together with a virtualization context menu to a user device. Accordingly, the user device, user personal information, and user assets can be protected from external threats contained in the context menu and the events associated therewith.

In addition, according to the present disclosure, context menu data itself is not encrypted, and each of events included in the context menu is encrypted. The present discloser may strengthened the security of the user device by receiving and processing only one event requested by the user device as a key value.

In addition, according to the present disclosure, there is no need to install a separate security program to protect the user device from external threats such as malicious URLs. Moreover, even in the case of a separate server that protects the device from malicious URLs, since only an isolated browser is required to execute the URL, a development cost for providing a service can be greatly reduced.

The effects according to the present disclosure are not limited by the contents exemplified above, and more various effects are included in the present disclosure.

### BRIEF DESCRIPTION OF THE DRAWINGS

FIG. 1 is a schematic diagram for explaining an outline of a conventional web browsing system.

FIG. 2 is a schematic diagram for explaining an outline of a remote security service providing system according to an exemplary embodiment of the present disclosure.

FIG. 3 is a block diagram illustrating a configuration of a remote security service providing server according to an exemplary embodiment of the present disclosure.

FIG. 4 is a schematic flowchart of a method for providing a remote security service according to an exemplary embodiment of the present disclosure.

FIGS. 5A to 5C are schematic diagrams for explaining an encrypted context menu event according to an exemplary embodiment of the present disclosure.

FIG. 6 is a schematic diagram for explaining interactions between respective components in the remote security service providing system according to an exemplary embodiment of the present disclosure.

### DETAILED DESCRIPTION OF THE EMBODIMENT

Advantages and features of the present disclosure and methods to achieve them will become apparent from descriptions of embodiments herein below with reference to the accompanying drawings. However, the present disclosure is not limited to the embodiments disclosed herein but may be implemented in various different forms. The embodiments are provided to make the description of the present disclosure thorough and to fully convey the scope of the present disclosure to those skilled in the art. It is to be noted that the scope of the present disclosure is defined only by the claims. In connection with the description of drawings, the same or like reference numerals may be used for the same or like elements.

In the disclosure, expressions “have,” “may have,” “include” and “comprise,” or “may include” and “may comprise” used herein indicate presence of corresponding features (for example, elements such as numeric values, functions, operations, or components) and do not exclude the presence of additional features.

In the disclosure, expressions “A or B,” “at least one of A or/and B,” or “one or more of A or/and B,” and the like used herein may include any and all combinations of the associated listed items. For example, the “A or B,” “at least one of A and B,” or “at least one of A or B” may refer to all of case (1) where at least one A is included, case (2) where at least one B is included, or case (3) where both of at least one A and at least one B are included.

The expressions, such as “first,” “second,” and the like used herein, may refer to various elements, but do not limit the order and/or priority of the elements. Furthermore, such expressions may be used to distinguish one element from another element but do not limit the elements. For example, a first user device and a second user device indicate different user devices regardless of the order or priority. For example, without departing from the scope of the present disclosure, a first element may be referred to as a second element, and similarly, a second element may also be referred to as a first element.

It will be understood that when an element (for example, a first element) is referred to as being “(operatively or communicatively) coupled with/to” or “connected to” another element (for example, a second element), it can be understood as being directly coupled with/to or connected to another element or coupled with/to or connected to another element via an intervening element (for example, a third element). On the other hand, when an element (for example, a first element) is referred to as being “directly coupled with/to” or “directly connected to” another element (for example, a second element), it should be understood that there is no intervening element (for example, a third element) therebetween.

According to the situation, the expression “configured to (or set to)” used herein may be interchangeably used with, for example, the expression “suitable for,” “having the capacity to,” “designed to,” “adapted to,” “made to,” or “capable of”. The term “configured to (or set to)” may not necessarily mean only “specifically designed to” in hardware. Instead, the expression “a device configured to” in any situation may mean that the device is “capable of operating together with another device or other components. For example, a “processor configured to (or set to) perform A, B, and C” may mean a dedicated processor (for example, an embedded processor) for performing a corresponding operation or a generic-purpose processor (for example, a central processing unit (CPU) or an application processor) which may perform corresponding operations by executing one or more software programs which are stored in a memory device.

Terms used in the present disclosure are used to describe specified embodiments of the present disclosure and are not intended to limit the scope of other embodiments. The terms of a singular form may include plural forms unless otherwise specified. All the terms used herein, which include technical or scientific terms, may have the same meaning that is generally understood by a person skilled in the art. It will be further understood that terms which are defined in a dictionary among terms used in the disclosure, can be interpreted as having the same or similar meanings as those in the relevant related art and should not be interpreted in an idealized or overly formal way, unless expressly defined in the present disclosure. In some cases, even in the case of terms which are defined in the specification, they cannot be interpreted to exclude embodiments of the present disclosure.

Features of various exemplary embodiments of the present disclosure may be partially or fully combined or coupled. As will be clearly appreciated by those skilled in the art, technically various interactions and operations are possible, and respective embodiments may be implemented independently of each other or may be implemented together in an associated relationship.

For clarity of interpretation of the present specification, terms used herein will be defined below.

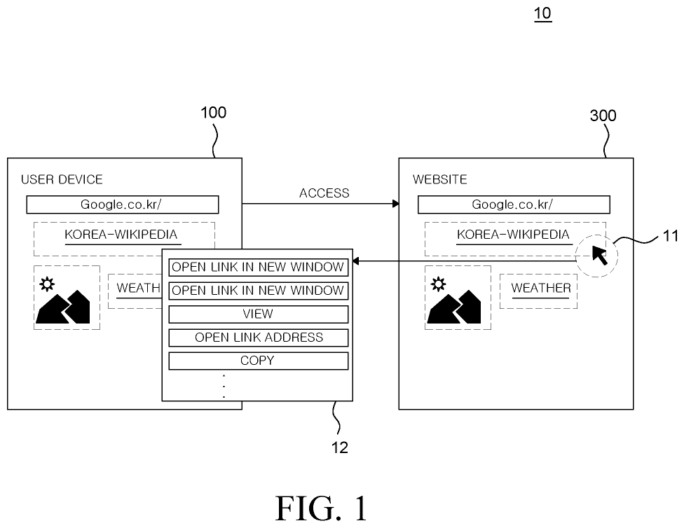

FIG. 1 is a schematic diagram for explaining an outline of a conventional web browsing system.

Referring to FIG. 1, a conventional web browsing system 10 is configured to deliver a context menu that is previously specified in a website 300 and pieces of event data constituting the context menu to a user device 100. For example, the user device 100 accessing the website 300 may acquire a context menu 12 corresponding to any one item in a screen of a web page from the website 300 by an operation 11 of clicking a right button through a mouse that is connected to the user device 100.

In addition, even in the case of a remote server (not illustrated) that is separated from the conventional user device 100, since a screen of a web page accessed is delivered as it is according to a request of the user device 100, the context menu 12 may also be delivered to the user device 100 without any verification or processing.

In this manner, when the context menu 12 generated from the website 300 is delivered to the user device 100 as it is, the user device 100 may be at threat in a case when a malicious code is attached to the context menu 12.

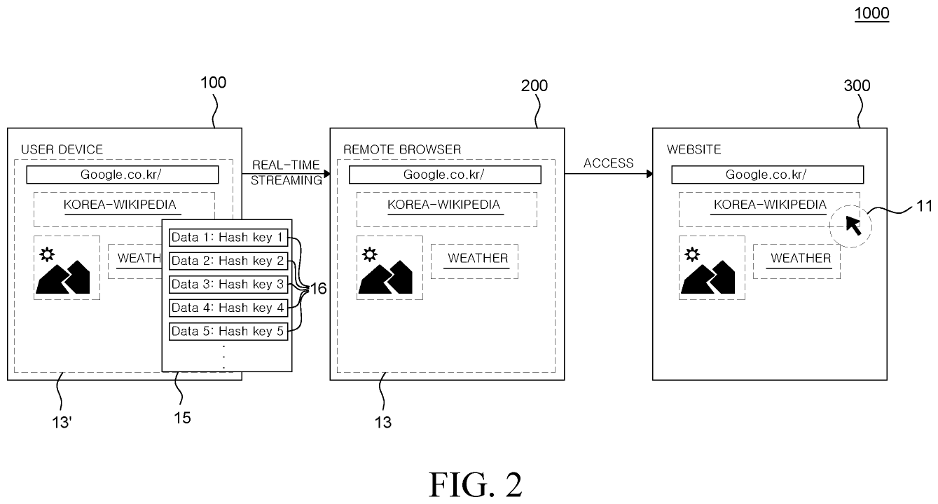

FIG. 2 is a schematic diagram for explaining an outline of a remote security service providing system according to an exemplary embodiment of the present disclosure.

Referring to FIG. 2, a remote security service providing system 1000 according to an exemplary embodiment of the present disclosure may include the user device 100 and a remote security service providing server 200.

The user device 100 may use a security service provided by the remote security service providing server 200. The user device 100 may be various types of devices that are possessed and carried by a user. For example, the user device 100 may include a smart phone, a personal computer (PC), a tablet PC, and the like.

The user device 100 may have different methods of acquiring an execution event for displaying a context menu depending on a type thereof. For example, when the user device 100 is a PC, the user device 100 may acquire an execution event by clicking an auxiliary button (usually, a right button) of an input device connected thereto. As another example, when the user device 100 is a smart phone or a tablet PC, the user device 100 may acquire an execution event through an operation of selecting a point on the web page screen for a predetermined time. However, this is only an example, and methods of acquiring an execution event for displaying a context menu may vary according to the user device 100 or settings of a browser installed in the user device 100.

The remote security service providing server 200 may provide a security service in a remote location separated from the user device 100. The remote security service providing server 200 may not provide context menu events provided from a website or a web browser to the user device 100 as they are, but may provide encrypted context menu events.

In an exemplary embodiment of the present disclosure, the remote security service providing server 200 may provide a real-time streaming service for the website 300 that is currently being accessed, to the user device 100. Specifically, the remote security service providing server 200 may access a link that is selected by the user device 100 in place of the user device 100. After that, the remote security service providing server 200 may render and stream the screen. Accordingly, a web page screen 13 that is accessed through a remote browser by the remote security service providing server 200 and a web page screen 13′ output from the user device 100 may include the same URL address bar and web page configuration. That is, the remote security service providing server 200 may provide a user experience as if all of operations commanded by the user device 100 are being performed in the user device 100.

However, when the user device 100 is intended to execute the context menu by the operation 11 of clicking the right button, the remote security service providing server 200 may stream the web page screen including the context menu as it is. Or, the remote security service providing server 200 may provide an encrypted context menu 15 without providing context menu data as it is. For example, the remote security service providing server 200 may encrypt events Data 1, Data 2, Data 3, Data 4, and Data 5 constituting the context menu through a hash function. The remote security service providing server 200 may provide a virtualization context menu 15 including encrypted hash values (key(n)=hash(data(n), where n is a natural number greater than or equal to 2)) to the user device 100. Here, items encrypted by the remote security service providing server 200 may include text, images, URLs, and the like constituting each event in the context menu.

In various exemplary embodiments, the remote security service providing server 200 may encrypt and provide different events included in the context menu according to items selected by the user on the web page screen. For example, the remote security service providing server 200 may encrypt and provide events such as “go to the previous page” and “go to the next page” as a context menu event corresponding to a blank screen. The remote security service providing server 200 may encrypt and provide an event such as “address copy” as a context menu event corresponding to a link.

Meanwhile, in FIG. 2, as the remote security service providing server 200 provides encrypted context menu events, the encrypted context menu 15 output to the user device 100 is illustrated as being composed of hash keys. However, this illustration is provided for the convenience of explanation. In the present disclosure, the context menu 15 output to the user device 100 may be the virtualization context menu 15 that is newly generated by the remote security service providing server 200. Each events constituting the virtualization context menu 15 may be matched with encrypted key values.

In this manner, the remote security service providing server 200 may provide only a key value corresponding to the event when a specific event is executed while the real-time streaming service is provided. That is, the remote security service providing server 200 may safely protect the user device 100 from various pieces of data that can be delivered to the user device 100 according to the execution of the event.

Hereinafter, a configuration of the remote security service providing server 200 that provides such a remote security service will be described.

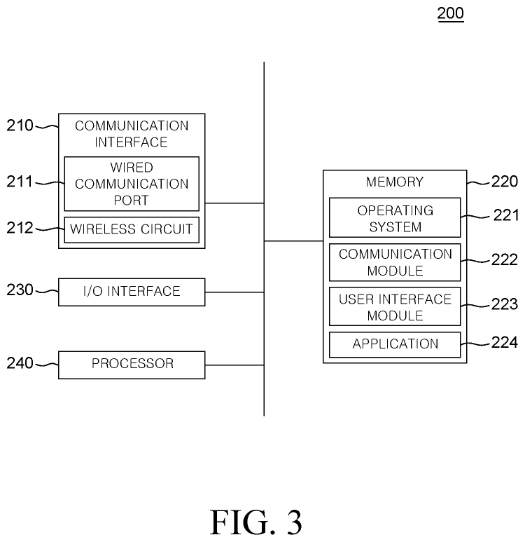

FIG. 3 is a block diagram illustrating a configuration of a remote security service providing server according to an exemplary embodiment of the present disclosure.

Referring to FIG. 3, the remote security service providing server 200 (hereinafter, referred to as a remote security server 200) may include a communication interface 210, a memory 220, a I/O interface 230 and a processor 240, and respective components may communicate with each other via one or more communication buses or signal lines.

The communication interface 210 may be connected to the user device 100 through a wired/wireless communication network to receive and send data. For example, the communication interface 210 may receive browser access data, browser setting data, user identification data, context menu execution events, the respective events constituting the virtualization context menu 15, and any one hash value matched with the event and selected by the user. For another example, the communication interface 210 may transmit the web page screen to the user device 100 through streaming, and may transmit the hash values of the events encrypted by the hash function.

Meanwhile, the communication interface 210 that enables transmission and reception of such data includes a wired communication port 211 and a wireless circuit 212. Here, the wired communication port 211 may include one or more wired interfaces, for example, Ethernet, a universal serial bus (USB), a FireWire, and the like. Also, the wireless circuit 212 may transmit and receive data to and from an external device through an RF signal or an optical signal. In addition, wireless communications may use at least one of a plurality of communication standards, protocols and technologies, such as GSM, EDGE, CDMA, TDMA, Bluetooth, Wi-Fi, VoIP, Wi-MAX, or any other suitable communication protocols.

The memory 220 may store various pieces of data used in the remote security server 200. For example, the memory 220 stores identification information of the user device 100 that is providing the remote security service. The memory 220 may store the context menu (browser setting data) by each type of web browser, a plurality of events included in the menu, and the hash values of the events encrypted by the hash function, and the like.

In various exemplary embodiments, the memory 220 may include a volatile or non-volatile recording medium capable of storing various pieces of data and information and various commands. For example, the memory 220 may include at least one type of storage medium among a flash memory type, a hard disk type, a multimedia card micro-type, a card type memory (e.g., an SD or XD memory), RAM, SRAM, ROM, EEPROM, PROM, a network storage, a cloud, and a blockchain database.

In various exemplary embodiments, the memory 220 may store a configuration of at least one of an operating system 221, a communication module 222, a user interface module 223, and one or more applications 224.

The operating system 221 (e.g., embedded operating systems such as LINUX, UNIX, MAC OS, WINDOWS, VxWorks, and the like) may include various software components and drivers for controlling and managing general system operations (e.g., memory management, storage device control, power management, and the like) and may support communications between various hardware, firmware, and software components.

The communication module 223 may support communications with other devices through the communication interface 210. The communication module 220 may include various software components for processing data received by the wired communication port 211 or the wireless circuit 212 of the communication interface 210.

The user interface module 223 may receive a user's request or input from a keyboard, a touch screen, a microphone, or the like through the I/O interface 230 and provide a user interface on a display.

The application 224 may include programs or modules that are configured to be executed by one or more processors 240. Here, the application for providing the remote security service may be operated on a server farm.

The I/O interface 230 may connect an input/output device (not illustrated) of the remote security server 200, for example, at least one of a display, a keyboard, a touch screen, and a microphone to the user interface module 223. The I/O interface 230 may receive a user input (e.g., a voice input, a keyboard input, a touch input, or the like) together with the user interface module 223 and process a command according to the received input.

The processor 240 may be connected to the communication interface 210, the memory 220, and the I/O interface 230 to control an overall operation of the remote security server 200. The processor 240 may execute an application or program stored in the memory 220 and may perform various commands corresponding thereto. For example, the processor 240 may safely protect the user device 100 from external threats (e.g., malicious codes attached to a URL) that may occur from the context executed in the user device 100 by performing the above commands.

The processor 240 may correspond to a computing device such as a central processing unit (CPU) or an application processor (AP). In addition, the processor 240 may be implemented in a form of an integrated chip (IC) such as a system on chip (SoC) in which various computing devices are integrated. Alternatively, the processor 240 may include a module for calculating an artificial neural network model, such as a neural processing unit (NPU).

Hereinafter, a method for providing a security service in which the processor 240 can safely execute events included in the context menu in a remote environment will be described.

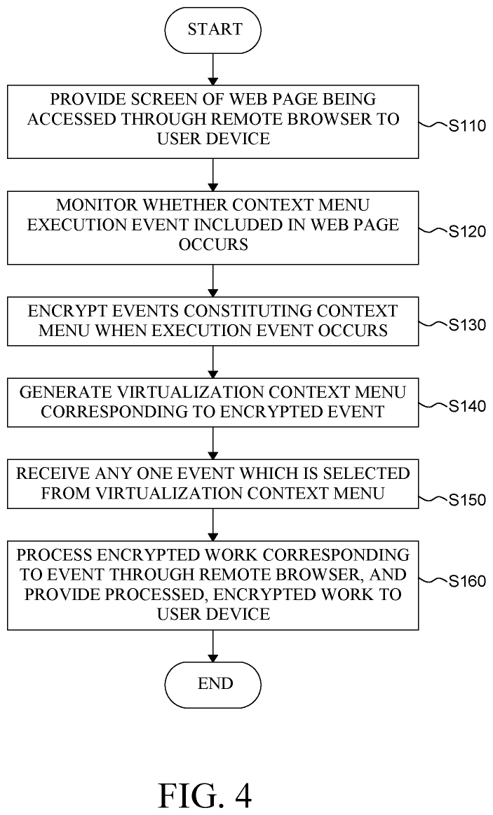

FIG. 4 is a schematic flowchart of a method for providing a remote security service according to an exemplary embodiment of the present disclosure.

Referring to FIG. 4, the processor 240 may provide the web page screen that is being accessed through the remote browser to the user device 100 (S110). For example, the processor 240 may receive a link selected by the user from the user device 100. The processor 240 may access the received link through the remote browser.

In various exemplary embodiments, the processor 240 may acquire browser access data from the user device 100 through the communication interface 210. The processor 240 may render a web page corresponding to the browser access data through the remote browser. Here, the browser access data may include an operating system of the user device 100, a browser type, and browser setting data of a user. For example, the operating system may include Windows, Mac OS, Linux, Unix, and the like, and the browser type may include Chrome, Explorer, Microsoft Edge, Firefox, Safari, Opera, a web browser based on a smartphone operating system, and the like. The browser setting data of the user is setting data customized by the user in basic setting data by each browser. The browser setting data of the user may be defined as an event arbitrarily changed by the user in the context menu.

In this manner, the processor 240 may render the web page screen in accordance with a website and an environment defined by the user from the user device 100. The processor 240 may share the rendered screen with the user device 100 in real time.

In addition, the processor 240 may encrypt different context menu events by reflecting the operating system and browser type and browser settings of the user through the browser access data.

After step S110, the processor 240 may monitor whether an execution event for the context menu (hereinafter, referred to as “context menu execution event”) included in the web page occurs (S120). Specifically, the processor 240 may acquire a user interaction acquired from the user device 100 through the communication interface 210. The processor 240 may determine whether the context menu execution event occurs. For example, the processor 240 acquires a user interaction such as whether an auxiliary button of the input device connected to the user device 100 is clicked or whether an operation of selecting a point on the web page screen for a predetermined time is performed. The processor 240 may determine whether the context menu execution event has occurred.

If the context menu execution event occurs, the processor 240 may confirm a type of an item selected through the user device 100 among items constituting the web page screen. Here, the items constituting the web page screen may include a background image, an inserted image, a video, text, and the like, that are output to the web page. Each item may include a context menu composed of different events, and depending on the type of the item, the context menu may not include a separate link (URL) or event. Accordingly, the processor 240 may confirm whether the link (URL) or event corresponding to the item exists.

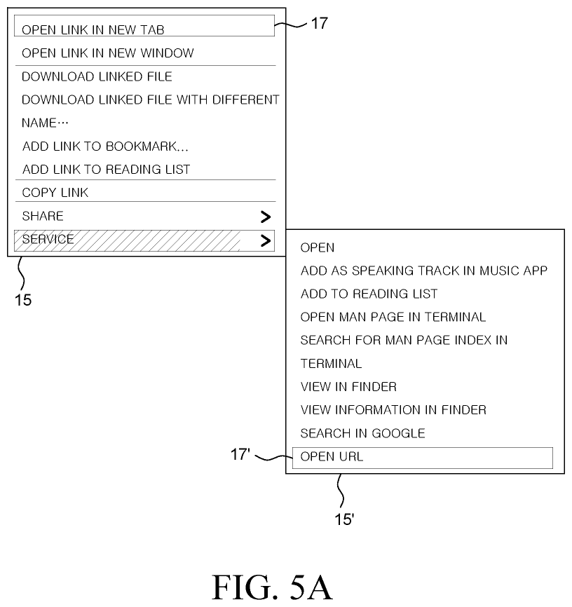

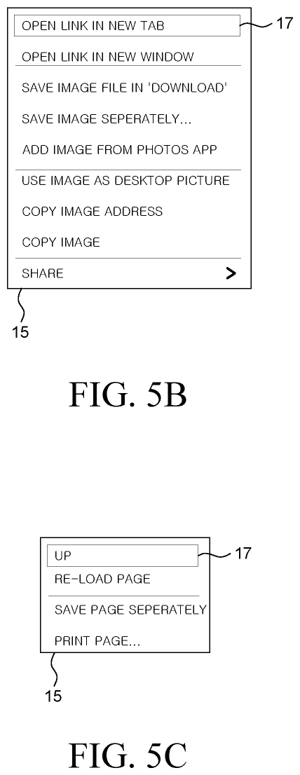

In connection with this, FIGS. 5A to 5C are schematic diagrams for explaining an encrypted context menu event according to an exemplary embodiment of the present disclosure.

Referring to FIGS. 5A to 5C, the web page screen may include different context menu events by each item. For example, through the user device 100, when a link (URL) composed of text on the web page screen is clicked by the auxiliary button, the processor 240 may confirm the context menu 15 corresponding to a corresponding item as illustrated in FIG. 5A. The corresponding context menu 15 includes a plurality of different events 17. Each plurality of different events 17 may have a new context menu 15′ and a plurality of new events 17′ included therein according to the type. As another example, through the user device 100, when an image on the web page screen is clicked by the auxiliary button, the processor 240 may confirm the context menu 15 corresponding to a corresponding item and the plurality of events 17 included in the context menu 15 as illustrated in FIG. 5B. In this case, depending on a type of an image item output to the web page, a link (URL) may be attached to the image.

As another example, through the user device 100, when a blank screen of the web page screen is clicked by the auxiliary button, the processor 240 may confirm the context menu 15 corresponding to the corresponding item and the plurality of events 17 included in the context menu 15, as illustrated in FIG. 5C. Here, in the case of the blank screen output to the web page, it can be confirmed that a link connected to the blank screen does not exist.

In this manner, the plurality of events constituting the context menu may be composed of work data including at least one of a link (URL) corresponding to a web page item, and an image and text constituting the event. Here, the work data may mean data for the processor 240 to execute events such as “back”, “save an image with a different name”, and “copy an image”.

Referring to FIG. 4 again, after step S120, when the execution event occurs, the processor 240 may encrypt the events constituting the context menu (S130). Specifically, the processor 240 may encrypt a link or different events confirmed in the context menu according to which item the user selects on the web page screen, and acquire encrypted key values.

In various exemplary embodiments, the processor 240 may input each of the plurality of events constituting the context menu into a hash function to thereby acquire a hash value for each of the plurality of events. The processor 240 may store the acquired hash values in the memory 220.

After step S130, the processor 240 may generate a virtualization context menu corresponding to the encrypted event (S140). Specifically, the processor 240 may generate a virtualization context menu corresponding to an item selected in the user device 100, on the web page screen. The processor 240 may transmit a hash value for each of a plurality of events included in the virtualization context menu together with the virtualization context menu, to the user device 100.

In various exemplary embodiments, the virtualization context menu generated by the processor 240 may be configured with the same image as a context menu executed through the browser installed in the user device 100. For example, the virtualization context menu may have the same text and layout as the context menus and events shown in FIGS. 5A to 5C above. The virtualization context menu may generated with the same configuration as the context menu event edited by the user according to the identification information of the user device 100.

After step S140, the processor 240 may receive any one event that is selected from the virtualization context menu (S150). The prosessor 240 may process an encrypted work corresponding to the event through the remote browser, and provide the processed, encrypted event to the user device 100 (S160). Here, processing and providing the encrypted work may be understood as the processor 240 executing the encrypted work through the remote browser and providing the executed screen to the user device 100.

Specifically, the processor 240 may receive a hash value corresponding to an event selected in the virtualization context menu from the user device 100 among hash values for each of the plurality of events. Accordingly, the processor 240 may determine an event corresponding to the received hash value among a plurality of events of a context menu corresponding to any one item based on the hash value. In addition, a work corresponding to the event that is previously determined may be processed through the remote browser, and a processed, new web page screen may be rendered.

So far, the remote security server 200 according to an exemplary embodiment of the present disclosure and a method for providing a remote security service using the same have been described. According to the present disclosure, the remote security service providing server 200 may encrypt the context menu included therein while executing the URL in the isolated browser. Accordingly, the remote security service providing server 200 may prevent in advance a situation in which a threat such as a malicious code is transmitted to the user device 100 as it is, and in addition, the user' personal information and assets may be protected.

Hereinafter, an overall process of providing a remote security service through the remote security service providing system 1000 will be described.

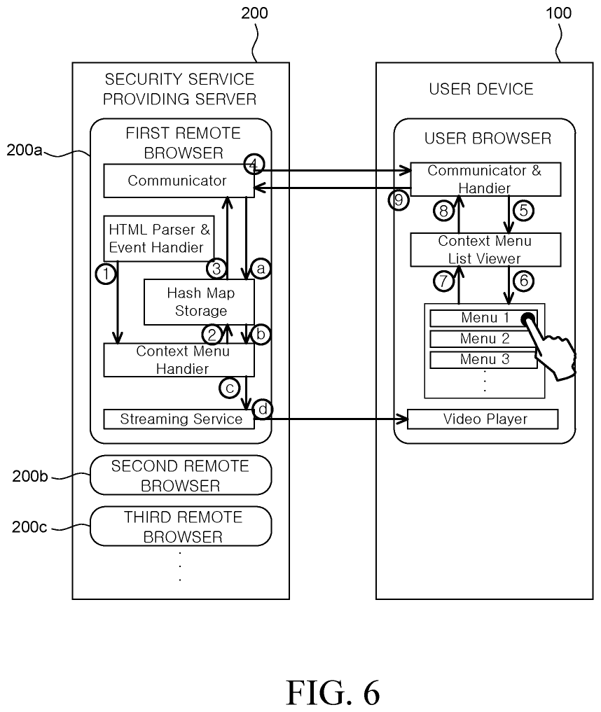

FIG. 6 is a schematic diagram for explaining interactions between respective components in the remote security service providing system according to an exemplary embodiment of the present disclosure.

Referring to FIG. 6, the remote security providing server 200 may include a plurality of remote browsers matching the user device 100. A plurality of remote browsers 200a, 200b, and 200c are respectively connected to different user devices 100. The plurality of browsers may be configured as separate environments in which data is not shared with each other.

While the remote security service is provided, a screen that is streamed in the remote browser of the remote security providing server 200 may be output from the browser of the user device 100.

When the context menu execution event occurs by the user device 100, the remote browser of the remote security providing server 200 may acquire the context menu included in the web browser through an HTML parser and an event handler (\textcircled{1}). Here, acquiring the context menu may be understood as acquiring work data related to a plurality of events constituting the context menu. For example, the remote security providing server 200 may acquire work data including at least one of a link (URL) corresponding to a web page item, and an image and text constituting the event.

Thereafter, the remote security providing server 200 may encrypt the plurality of events constituting the context menu by a hash function through a context menu handler. The remote security providing server 200 may store encrypted hash values in a hash map storage (\textcircled{2}). The remote security providing server 200 may transmit the encrypted hash values and the virtualization context menu to a user browser of the user device 100 through a communicator (\textcircled{3}) (\textcircled{4}).

The user device 100 may output the virtualization context menu through a context menu list viewer (\textcircled{5}), and the user may select one of these events (\textcircled{6}). Accordingly, the user device 100 may transmit the hash value corresponding to the event back to the remote security providing server 200 through the communicator (\textcircled{7}) (\textcircled{8}) (\textcircled{9}).

The remote security providing server 200 may search for any one event corresponding to the hash value received from the hash map storage (\textcircled{a}). And, work data corresponding to the searched event may be processed through the context menu handler (\textcircled{b}), and the processed web page screen may be rendered (\textcircled{c}).

The remote security providing server 200 may transmit a stream to the user browser of the user device 100 as a streaming service. The browser of the user device 100 may reproduce the stream (\textcircled{d}).

So fat, the overall process of providing the remote security service has been described. According to the present disclosure, the remote security providing server 200 does not encrypt the context menu data itself, and encrypts each of the events included in the context menu. The remote security providing server 200 receives only one event requested by the user device as a key value to process the event, so that security of the user device can be strengthened.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A method for providing a remote security service, the method comprising:
providing a screen of a web page being accessed through a remote browser to a user device;
monitoring whether an execution event for a context menu included in the web page occurs;
encrypting an event constituting the context menu when the execution event occurs;
generating a virtualization context menu corresponding to the encrypted event;
receiving any one event selected from the virtualization context menu; and
processing an encrypted work corresponding to the event through the remote browser, and providing the processed, encrypted work to the user device.

2. The method of claim 1, further comprising:
after the monitoring of whether the event occurs,
confirming a type of an item selected through the user device among items constituting the screen of the web page.

3. The method of claim 2, wherein the items constituting the screen of the web page include at least one item of a background image, an inserted image, a video, and text,
wherein the confirming of the type includes confirming whether a link (URL) or event corresponding to the item exists.

4. The method of claim 3, wherein the encrypting of the event includes encrypting data constituting the confirmed link or event.

5. The method of claim 4, wherein the encrypting of the data further includes inputting each of a plurality of events constituting the context menu into a hash function; and acquiring hash values for each of the plurality of events.

6. The method of claim 5, wherein the plurality of events are composed of work data including at least one of a link (URL) corresponding to the item, and an image and text constituting the event.

7. The method of claim 5, wherein the generating of the virtualization context menu further includes,
transmitting the hash values for each of the plurality of events to the user device,
wherein the providing to the user device further includes,
receiving a hash value corresponding to the selected event among the hash values for each of the plurality of events.

8. The method of claim 7, wherein the providing to the user device further includes,
determining an event corresponding to the received hash value among the plurality of events, and
processing a work corresponding to the event determined through the remote browser, and rendering a processed new web page screen.

9. The method of claim 1, wherein the providing of the screen of the web page further includes,
acquiring browser access data from the user device, and rendering a web page corresponding to the browser access data.

10. The method of claim 9, wherein the browser access data includes at least one of an operating system of the user device, a browser type, and browser setting data of a user.

11. A remote security service providing server, comprising:
a communication interface;
a memory; and
a processor operatively coupled to the communication interface and the memory,
wherein the processor is configured to,
provide a screen of a web page, which is being accessed through a remote browser to a user device,
monitor whether an execution event for a context menu included in the web page occurs,
encrypt an event constituting the context menu when the execution event occurs,
generate a virtualization context menu corresponding to the encrypted event,
receive any one event which is selected from the virtualization context menu, and
process the encrypted event corresponding to the event through the remote browser, and provide the processed, encrypted event to the user device.

12. The remote security service providing server of claim 11, wherein the processor is configured to,
confirm a type of an item selected through the user device among items constituting the screen of the web page.

13. The remote security service providing server of claim 12, wherein the items constituting the screen of the web page include at least one item of a background image, an inserted image, a video, and text,
wherein the processor is configured to,
confirm whether a link (URL) or event corresponding to the item exists.

14. The remote security service providing server of claim 13, wherein the processor is configured to,
encrypt data constituting the confirmed link or event.

15. The remote security service providing server of claim 14, wherein the processor is configured to,
input each of a plurality of events constituting the context menu into a hash function, and acquire hash values for each of the plurality of events.

16. The remote security service providing server of claim 15, wherein the plurality of events are composed of work data including at least one of a link (URL) corresponding to the item, and an image and text constituting the event.

17. The remote security service providing server of claim 15, wherein the processor is configured to,
transmit the hash values for each of the plurality of events to the user device, and
receive a hash value corresponding to the selected event among the hash values for each of the plurality of events.

18. The remote security service providing server of claim 17, wherein the processor is configured to,
determine an event corresponding to the received hash value among the plurality of events, process a work corresponding to the determined event through the remote browser, and render a processed new web page screen.

19. The remote security service providing server of claim 11, wherein the processor is configured to,
acquire browser access data from the user device and render a web page corresponding to the browser access data.

20. The remote security service providing server of claim 19, wherein the browser access data includes,
at least one of an operating system of the user device, a browser type, and browser setting data of a user.
